(19) United States
(12) Patent Application Publication
(10) Pub. No.: US 2015/0193022 A1
(43) Pub. Date: Jul. 9, 2015

(54) WIRELESS MOUSE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: WEN-JUN ZHONG, Shenzhen (CN)

(21) Appl. No.: 14/584,254

(22) Filed: Dec. 29, 2014

(30) Foreign Application Priority Data
Jan. 3, 2014 (CN) 201410001625.X

(51) Int. Cl. G06F 3/0354; H02J 7/00; H02K 7/18

(52) U.S. Cl. CPC G06F 3/03543; H02K 7/1853; H02J 7/0068

(57) ABSTRACT

A wireless mouse includes several power generation devices each having a generator, a rotating member, a connection rod, a drive wheel and a slave wheel. The rotating member and the drive wheel are coupled to the connection rod. A stopper block is fixed on the rotating member with an end portion fitting into one gear of a ratchet portion defined on the connection rod. An elastic member is fixed between the connection rod and the drive wheel. The slave wheel is assembled on a rotating shaft of the generator, and engaged with the drive wheel. When the rotating member rotates, the connection rod is rotated unidirectional by the engagement of the stopper block and the ratchet portion, and the elastic member is deformed to rotate the drive wheel with the slave wheel, causing the rotating shaft of the generator to rotate and generate electrical energy to power the wireless mouse.

### CROSS-REFERENCE TO RELATED APPLICATIONS

This application claims priority to Chinese Patent Application No. 201410001625.X filed on Jan. 3, 2014, the contents of which are incorporated by reference herein.

### FIELD

The subject matter herein generally relates to wireless mouses, and particularly to a wireless mouse capable of self charging.

### BACKGROUND

An existing wireless mouse usually gets power from dry cell battery or rechargeable battery. Those batteries need to be replaced or charged frequently due to small capacity.

### BRIEF DESCRIPTION OF THE DRAWINGS

Implementations of the present disclosure will now be described, by way of example only, with reference to the attached figures.

FIG. 1 is an isometric view of a wireless mouse showing internal structure thereof

FIG. 2 is a cross-sectional view of the wireless mouse of FIG. 1.

FIG. 3 is an exploded view of the structure III of the wireless mouse of FIG. 2.

FIG. 4 is an isometric view of a wireless mouse of FIG. 1 viewed from another angle.

FIG. 5 is a cross-sectional view taken along line V-V of the wireless mouse of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

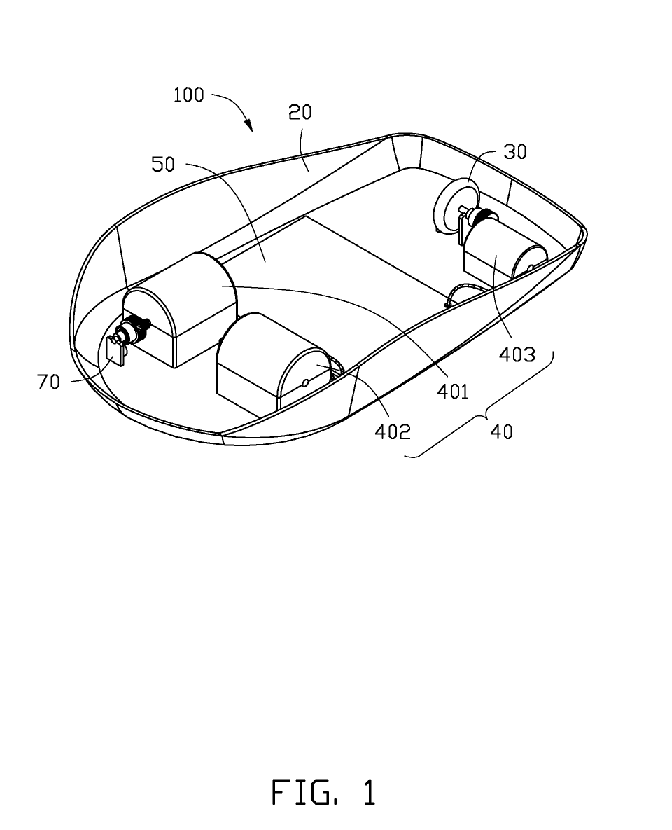

FIG. 1 illustrates a wireless mouse 100 includes a body 20, a scroll wheel 30, and at least one power generation device 40 and a circuit board 50 housed in the body 20.

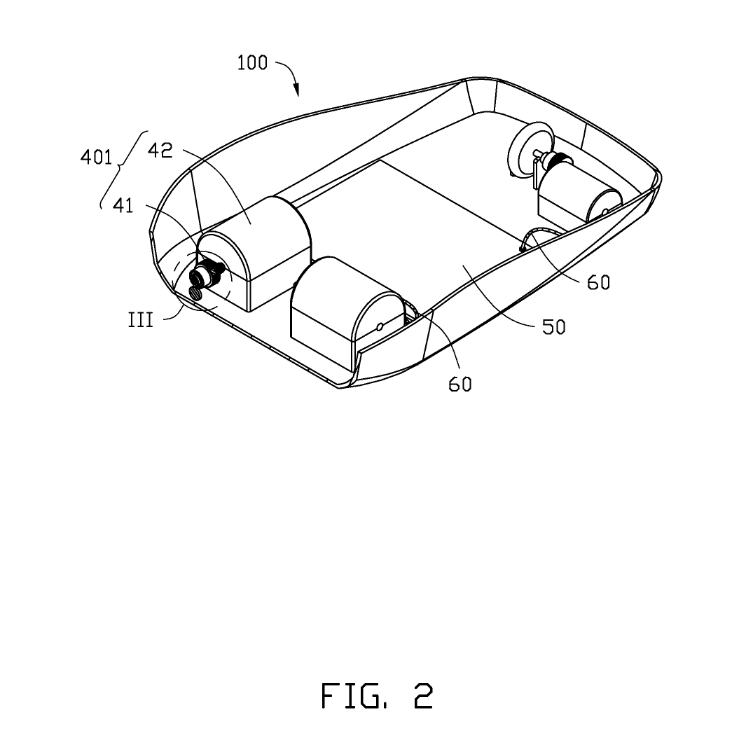

FIG. 2 illustrates that each power generation device 40 includes a direct current generator 42 fixed in the body 20 and a mechanical energy transmission device 41 coupled to the generator 42. The transmission device 41 is configured to collect mechanical energy generated by the movement of the wireless mouse 100 or the scrolling of the scroll wheel 30, and transmit the collected mechanical energy to the generator 42. In the illustrated embodiment, the generator 42 is driven by the collected mechanical energy to generate electrical energy. That is, the generator 42 is configured to convert the collected mechanical energy into electrical energy.

In the illustrated embodiment, the generator 42 is coupled to the circuit board 50 via cables 60, and is configured to output electrical energy to the circuit board 50 to power the wireless mouse 100. In other embodiments, the generator 42 outputs electrical energy to an electrical energy storage device (not shown) for storage.

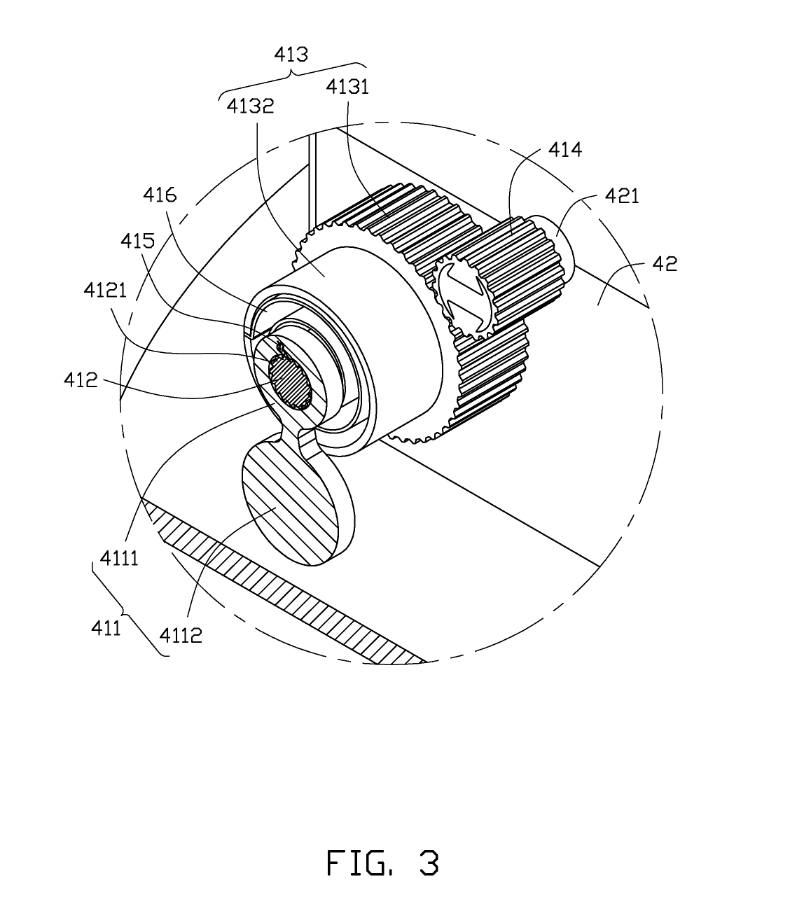

FIG. 3 illustrates that the transmission device 41 includes a rotating member 411, a connection rod 412, a drive wheel 413, and a slave wheel 414. The connection rod 412 is rotatably connected to an outside wall of the generator 42 with a free end portion away from the generator 42 resting on a supporting block 70 as shown in FIG. 1.

The rotating member 411 and the drive wheel 413 are coupled to the connection rod 412 and are able to rotate around the connection rod 412. In the illustrated embodiment, the connection rod 412 defines on an outside surface thereof a ratchet portion 4121. including a number of gears. The transmission device 41 further includes a stopper block 415 fixed on the rotating member 411 with a free end portion fitting one of the gears of the ratchet portion 4121.

The drive wheel 413 includes a main body 4131 and a hollow connection shaft 4132 extending from one end portion of the main body 4131. The transmission device 41 further includes an elastic member 416 received in the hollow connection shaft 4132 and wrapped around an outside surface of the connection rod 412. The elastic member 416 has one end portion fixed to the connection rod 412 and another end portion fixed to the hollow connection shaft 4132 of the drive wheel 413.

The slave wheel 414 is assembled on a rotating shaft 421 of the generator 42, and engaged with the drive wheel 413 via gears.

In use, when the rotating member 411 is driven to rotate, the connection rod 412 is rotated unidirectional by the engagement of the stopper block 415 and the gear of the ratchet portion 4121, the elastic member 416 is thus deformed to rotate the drive wheel 413, causing the slave wheel 414 is rotated by the engagement of the drive wheel 413 and the slave wheel 414. Thereby causing the rotating shaft 421 of the generator 42 to rotate and generate electrical energy to power the wireless mouse 100.

In the embodiment, FIG. 3 illustrates that when the rotating member 411 is rotated along a predetermined direction, such as clockwise direction, the rotating member 411 pushes the connection rod 412 along the clockwise direction by the engagement of the stopper block 415 and the gear of the ratchet portion 4121, and the elastic member 416 is thus deformed to rotate the drive wheel 413.

When the rotating member 411 is rotated along an opposite direction, such as counterclockwise, the stopper block 415 rotates with the rotating member 411 and goes out from the one gear and fits into another gear of the ratchet portion 4121 counterclockwise. At this time, the connection rod 412 does not rotate with the rotating member 411 counterclockwise, and the drive wheel 413, the slave wheel 414, and the rotating shaft 421 will not rotate due to the elastic member 416 remaining in a natural shape.

FIGS. 1-3 illustrate that in the illustrated embodiment, the at least one power generation device 40 includes a first generation device 401 and a second generation device 402 configured to collect mechanical energy generated by the movement of the wireless mouse 100 and convert the collected mechanical energy into electrical energy.

In the illustrated embodiment, each rotating member 411 of the first generation device 401 and the second generation device 402 includes a hollow sleeve 4111 and a pendulum 4112 extending from the hollow sleeve 4111. The rotating member 411 is assembled on the ratchet portion 4121 of the connection rod 412 through the hollow sleeve 4111, and the pendulum 4112 is driven to swing back and forth, that is to swing along a clockwise direction and a counterclockwise direction, under gravity when the wireless mouse 100 moves.

In one embodiment, the connection rod 412 of the first generation device 401 and the second generation device 402 are substantially perpendicular to each other, making the swing directions of the pendulum 4112 of the first generation device 401 and the second generation device 402 substantially perpendicular to each other, such that, when the wireless mouse 100 moves, at least one of the first generation device 401 and the second generation device 402 can collect mechanical energy.

In one embodiment, the connection rod 412 of the first generation device 401 and the second generation device 402 are respectively assembled along a length and a width of the body 20 of the wireless mouse 100.

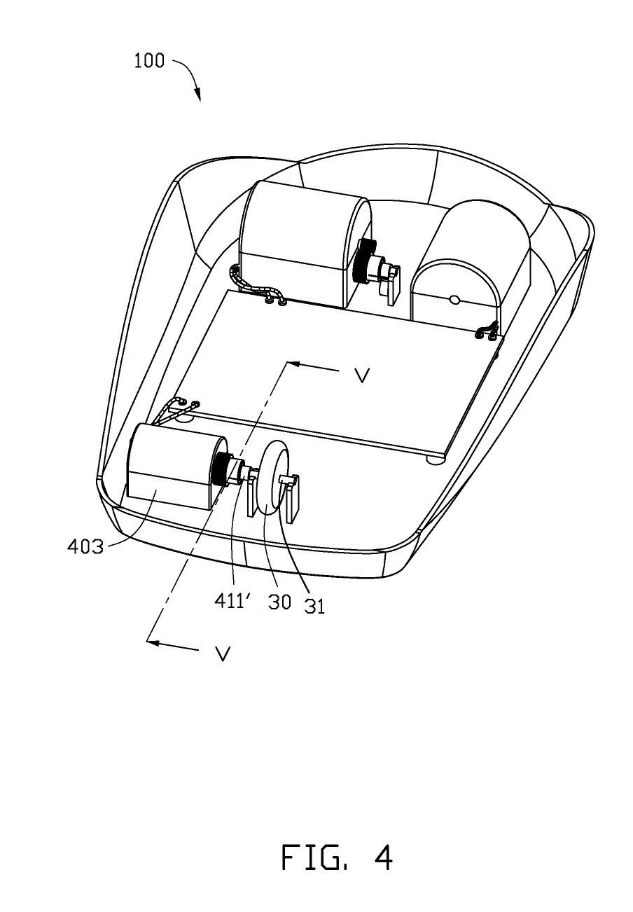

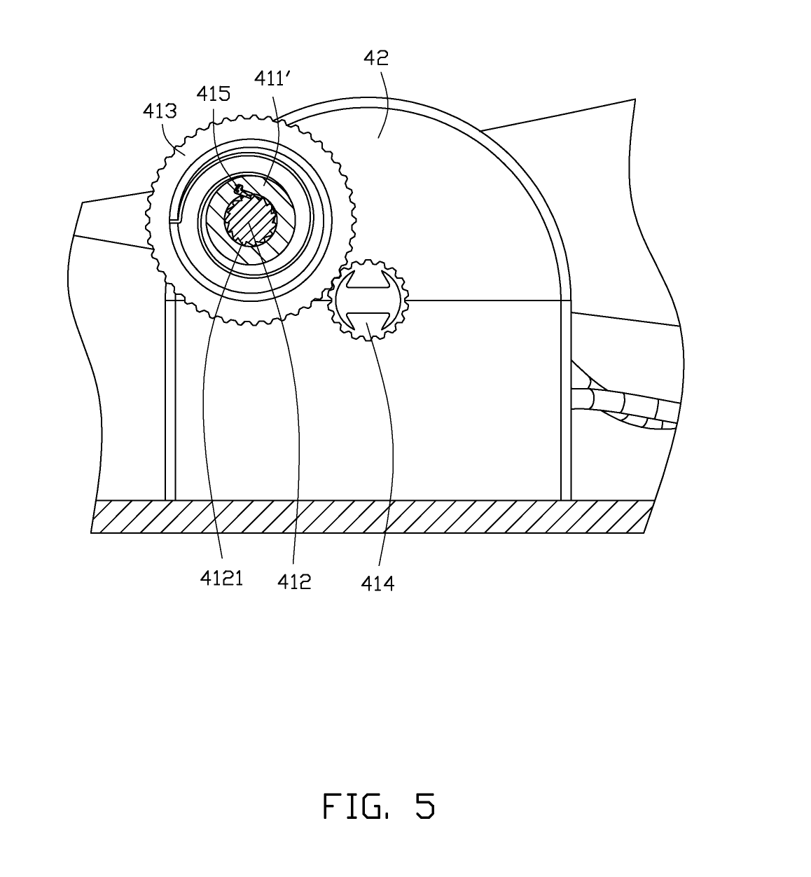

FIGS. 1, and 4-5 illustrate that the at least one power generation device 40 can further include a third generation device 403 configured to collect mechanical energy generated by the scrolling of the scroll wheel 30 and convert the collected mechanical energy into electrical energy.

In the illustrated embodiment, the rotating member 411′ of the third generation device 403 is fixed to a roller shaft 31 of the wireless mouse 100. When the scroll wheel 30 is scrolled forward or backward, the rotating member 411′ is rotated by the roller shaft 31 along a clockwise direction or a counterclockwise direction.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in particular the matters of shape, size, and arrangement of parts within the principles of the present disclosure, up to and including the full extent established by the broad general meaning of the terms used in the claims.

What is claimed is:

1. A wireless mouse comprising:
a body; and
at least one power generation device at least partially housed in the body, each power generation device comprising a generator fixed in the body and a transmission device coupled to the generator, the transmission device comprising:
a rotating member;
a drive wheel;
a connection rod defining on an outside surface thereof a ratchet portion comprising a plurality of gears, the connection rod rotatably connected to an outside wall of the generator, the rotating member and the drive wheel coupled to the connection rod and able to rotate around the connection rod;
a stopper block fixed on the rotating member with a free end portion fitting into one of the gears of the ratchet portion;
an elastic member wrapped around an outside surface of the connection rod, wherein the elastic member has one end portion fixed to the connection rod and another end portion fixed to the drive wheel; and
a slave wheel assembled on a rotating shaft of the generator, and engaged with the drive wheel via gears;
wherein when the rotating member is driven to rotate, the connection rod is rotated unidirectional by the engagement of the stopper block and the gear of the ratchet portion, the elastic member is thus deformed to rotate the drive wheel, causing the slave wheel is rotated by the engagement of the drive wheel and the slave wheel, thereby causing the rotating shaft of the generator to rotate and generate electrical energy to power the wireless mouse.

2. The wireless mouse as described in claim 1, wherein when the rotating member is rotated along a predetermined direction, the rotating member pushes the connection rod along the predetermined direction by the engagement of the stopper block and the gear of the ratchet portion, and the elastic member is thus deformed to rotate the drive wheel; when the rotating member is rotated along an opposite direction, the stopper block rotates with the rotating member and goes out from the one gear and fits into another gear of the ratchet portion along the opposite direction.

3. The wireless mouse as described in claim 2, wherein the at least one power generation device comprising a first generation device and a second generation device, wherein each rotating member of the first generation device and the second generation device comprises a hollow sleeve and a pendulum extending from the hollow sleeve, wherein the rotating member is assembled on the ratchet portion of the connection rod through the hollow sleeve, and the pendulum is driven to swing back and forth along the predetermined direction and the opposite direction under gravity when the wireless mouse moves.

4. The wireless mouse as described in claim 3, wherein the connection rod of the first generation device and the second generation device are substantially perpendicular to each other, making the swing directions of the pendulum of the first generation device and the second generation device substantially perpendicular to each other.

5. The wireless mouse as described in claim 4, wherein the connection rod of the first generation device and the second generation device are respectively assembled along a length and a width of the body of the wireless mouse.

6. The wireless mouse as described in claim 2, wherein the at least one power generation device comprising a third generation device, wherein the rotating member of the third generation device is fixed to a roller shaft of the wireless mouse, when a scroll wheel fixed to the roller shaft is scrolled forward or backward, the rotating member is rotated by the roller shaft along the predetermined direction or the opposite direction.

7. The wireless mouse as described in claim 1, further comprising a circuit board assembled in the body and coupled to the generator, wherein the generator outputs electrical energy to the circuit board to power the wireless mouse.

8. The wireless mouse as described in claim 1, wherein the generator outputs electrical energy to an electrical energy storage device for storage.
